(19) United States
(12) Patent Application Publication
(10) Pub. No.: US 2016/0012244 A1
(43) Pub. Date: Jan. 14, 2016

(54) AUTOMATED MANAGEMENT OF REPOSSESSION

(71) Applicant: SKYPATROL, LLC, Miami, FL (US)

(72) Inventors: MARK PETERS, Grand Prairie, TX (US); KEVIN ST. HILLAIRE, Miami, FL (US)

(21) Appl. No.: 14/325,612

(22) Filed: Jul. 8, 2014

(51) Int. Cl. G06F 21/62; B60R 25/045; G06Q 10/10

(52) U.S. Cl. CPC G06F 21/6218; G06Q 10/10; B60R 25/045

(57) ABSTRACT

A method for enhancing the management of vehicle repossession requests can include, in response to receiving a request for repossessing a vehicle from a title holder, generating a notification to a repossession agent. The notification can include a link permitting access to vehicle information. In response to receiving a request to access the vehicle information through the link, the vehicle information can be provided to the requester.

### BACKGROUND

A vehicle title holder, which may be a lender or automobile dealer, sometimes needs to take back the vehicle from the owner because a loan secured by the vehicle is in default. The title holder may then call on field repossession agents (sometimes colloquially called “repo men”) to remove the vehicle from the custody of the owner and return the vehicle to its title holder. In most cases, the repossession agents are mobile, independent contractors, so communication of vehicle information between the title holders and the repossession agents can be an information management challenge.

### BRIEF SUMMARY

Techniques are disclosed for enhancing the management of vehicle repossession activities. Techniques disclosed herein enable a vehicle title holder to easily initiate repossession of a vehicle using a repossession service to communicate vehicle information to repossession agents in the field with text, email, or application-based notifications. The notifications can include a link to the repossession service. Repossession agents can obtain pertinent information from the notification as well as gain controlled access to features available through the repossession service.

In some implementations, the link to the repossession service provides access to functionality and user interface views, allowing the repossession agents to easily verify vehicle information and locate a vehicle. In some implementations, commands for disabling and enabling the vehicle starter may be accessible to repossession agents through the user interface views. In some implementations, commands for confirming the successful completion of the vehicle repossession may be available.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an environment in which aspects of the disclosed techniques may be carried out, accompanied by related process flows.

FIGS. 2A and 2B show screens illustrating an example scenario for requesting repossession.

FIGS. 3A and 3B show screens illustrating an example scenario for a repossession agent.

FIGS. 4A and 4B present block diagrams illustrating components of systems that may be used to implement the techniques described herein.

FIG. 5 illustrates an example system architecture in which the described systems and techniques may be carried out.

### DETAILED DESCRIPTION

Techniques are disclosed for enhancing the management of vehicle repossession activities. As used herein, vehicles include any conveyance such as but not limited to automobiles, trucks, boats, recreational vehicles, trailers, motorcycles and bicycles. In addition to vehicle repossession, the described techniques and systems may be suitable for other items that may be repossessed.

Techniques disclosed herein enable a vehicle title holder to easily initiate repossession of a vehicle using a repossession service. The repossession service can, in response to receiving a repossession request, communicate vehicle information to repossession agents in the field with text, email, or application-based notifications. The notifications can include a link to the repossession service. Repossession agents can obtain pertinent information from the notification as well as gain controlled access to features available through the repossession service.

In some implementations, the link to the repossession service provides access to functionality and user interface views, allowing the repossession agents to easily verify vehicle information and locate a vehicle. Through the repossession service, repossession agents can be given access to certain functions for locating and disabling vehicles to be repossessed. The techniques also provide mechanisms for seamless interaction with available vehicle location services that utilize license plate readers or customized on-board vehicle devices.

The access of the repossession agents to the vehicle information can be limited so that private or otherwise confidential information can remain private while still easily communicating the information that the repossession agents may need to properly repossess the vehicle.

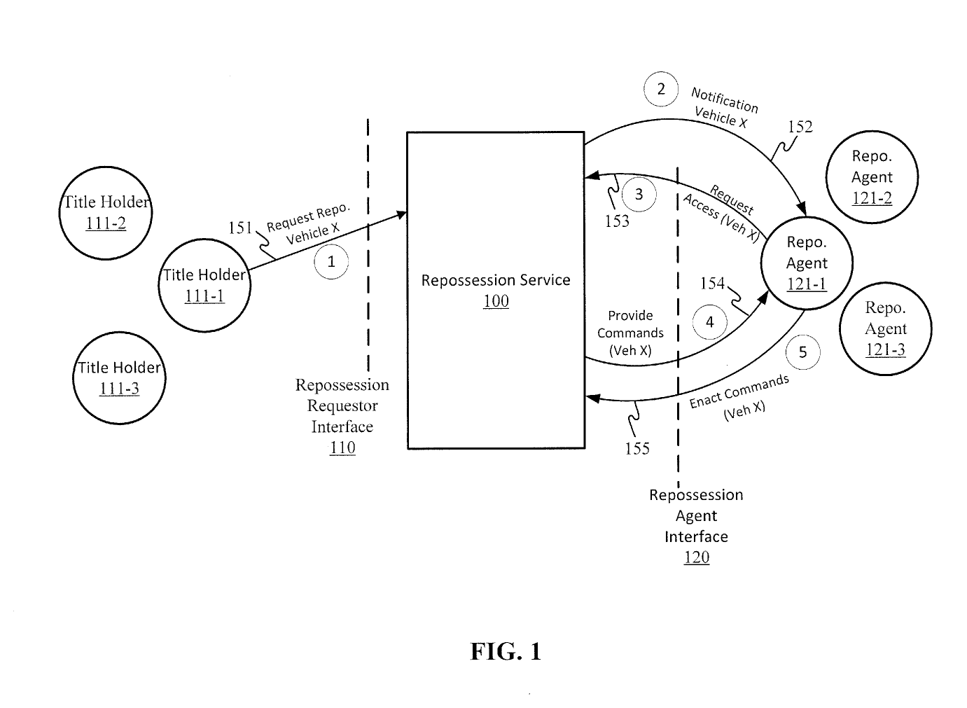

FIG. 1 shows an environment in which aspects of the disclosed techniques may be carried out, accompanied by related process flows. Referring to FIG. 1, a repossession service 100 can provide functionality and communicate with various parties. For example, the repossession service can include a repossession requestor interface 110 through which title holders, such as title holders 111-1, 111-2, and 111-3, may communicate and make requests.

“Title holders” are parties such as banks or credit unions who may have a lienholder or title interest in a vehicle as a result of having loaned money to the vehicle's owner. The title holder may have subscribed to repossession service to manage repossession activities as disclosed herein. In some situations, individual persons working as employees or authorized representatives of the title holder may make repossession requests to the repossession service 100 via a repossession requestor interface 110.

In some cases, the repossession request interface 110 is available through a web browser or web-based application running on a client device used by a title holder. In some cases, an account management application (native to the client device or web-based), can be used by the title holders to access and communicate with the repossession service 100. In some of such cases, the repossession requestor interface 110 may be an application programming interface; whereas in other of such cases, the repossession requestor interface 110 can be a user interface made available to the title holder.

The repossession service 100 can also include a repossession agent interface 120 through which a repossession agent, such as repossession agent 121-1, 121-2, or 121-3, may access select information about a vehicle to be repossessed and be given relevant commands and features. As with the repossession requestor interface 110, the repossession agent interface 120 may be available through a web browser or web-based application running on a client device used by a repossession agent.

The repossession service 100 can, in some cases, communicate with a messaging service to output requests from the title holders to an appropriate repossession agent (e.g., one or more of repossession agents 121-1, 121-2, and 121-3).

A “repossession requestor application” and a “repossession agent application” may be used to refer to the software features respectively available for the repossession requestor and repossession agent and which are enabled by the repossession service or provided for communication with the repossession service.

In some embodiments, repossession service 100 may be a web or cloud-based service that hosts functionality accessible to both repossession requestors and repossession agents. In these web or cloud-based scenarios, the repossession service may host vehicle data and functions for multiple repossession requestors and repossession agents, and the data and functions appropriate to each individual repossession requestor or agent will be divided and secured by appropriate filters and access controls. In some cases, the repossession service can include access management controls so that a title holder (or title holder account administrator) can select the information made available to a repossession agent. In some cases, the privacy and access management controls can be controlled via an accounts management application separate from, but in communication with the repossession service.

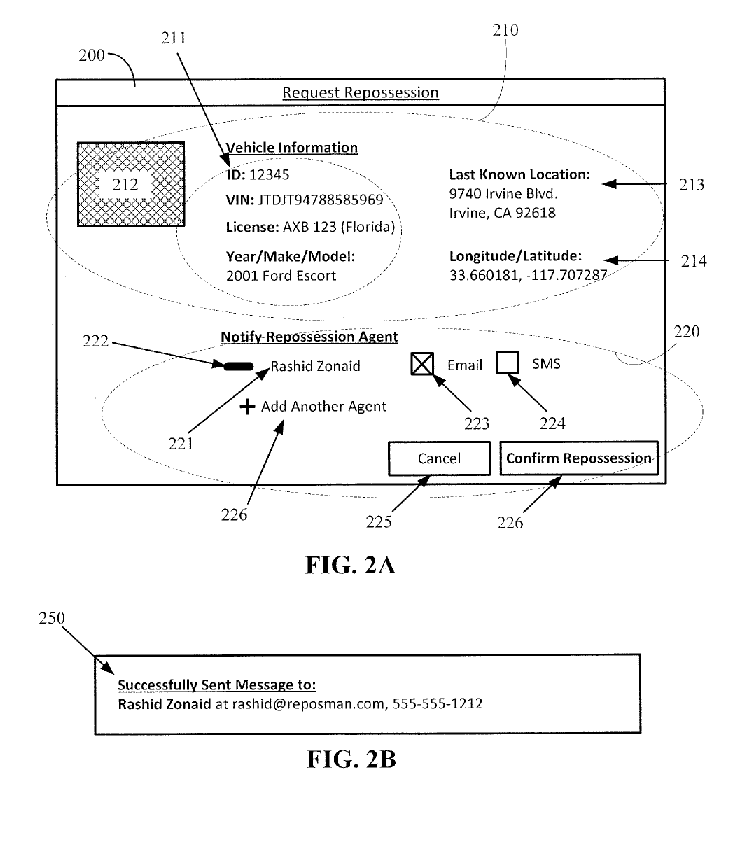

In an example scenario and process flow illustrated in FIG. 1, title holder 111-1 may, via a repossession requestor application that may be separate from or part of an account management application for managing properties to which the title holder holds title (and may be receiving payment), utilize the repossession service 100 to request to repossess “vehicle X” (151). Example implementations of selected requestor user interface views depicting the repossession request activities are shown in FIGS. 2A and 2B.

The repossession service 100 can, based on configured rights management for a particular account (which may be default setting or a custom/user-specified setting), generate a link for a repossession agent 121-1 in particular, or to any repossession agent in general, depending on implementation. The repossession service may communicate with a messaging application to send a message notification containing the link to the repossession agent 121-1 (152). In one alternative, the repossession service can provide the link to the title holder 111-1 so the title holder 111-1 can send the link. As yet another alternative, for repossession agents that may have their own account with the repossession service, the notification may be surfaced within the application the repossession agent is using that accesses the repossession service.

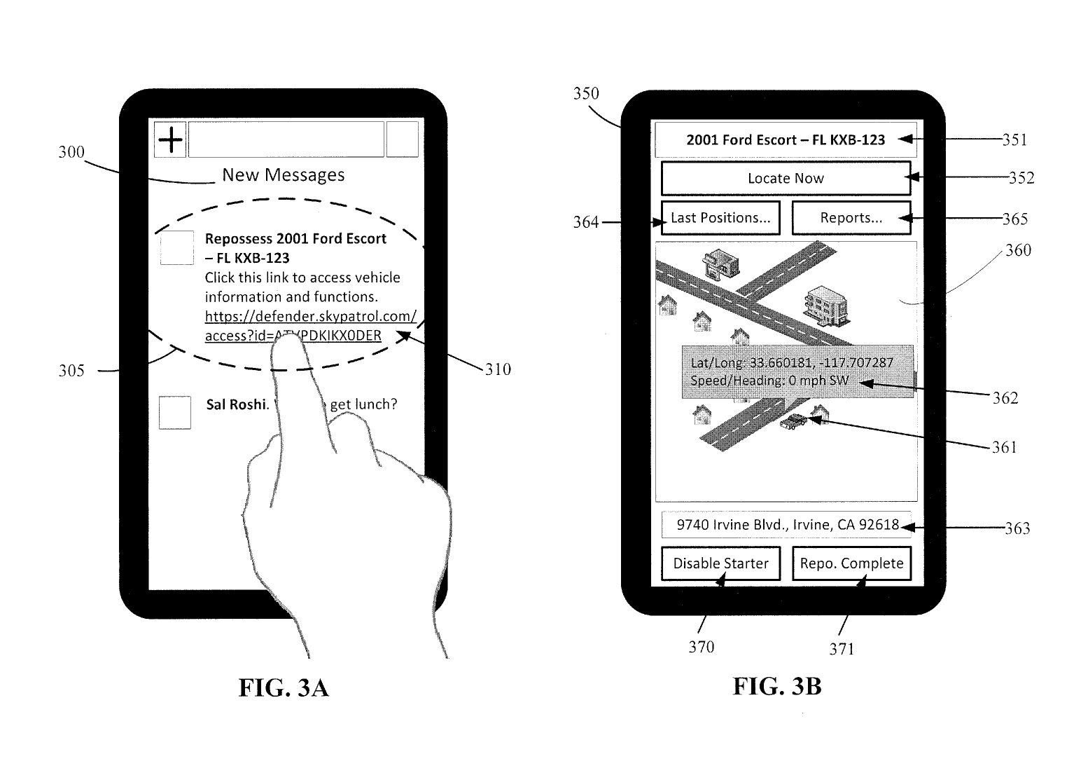

The notification containing the link (152) may take any or all of several forms, including a text message in SMS, MMS or other format or email message. The link, or hyperlink, is capable of directing a desktop, laptop, or mobile device application to open a browser and navigate to a user interface view containing relevant information and available commands or functions pertaining to the vehicle to be repossessed. In some cases, the link may direct a specialized mobile device “app” (application) to surface and display the relevant information and available functions about the vehicle. In some cases where the repossession agent is a frequent user of the repossession service and has installed a specialized mobile device application, the notification 152 may be a private communication directed to the repossession agent's specialized mobile device application work queue or notification interface. It should be noted that other forms of notification are possible and the proposed methods are for illustrative purposes and not intended to be limiting. Example screens for a repossession agent illustrating the described process are shown in FIGS. 3A and 3B.

After the repossession agent 121-1 receives the notification (152), the repossession agent 121-1 may then use the notification to request access to information and functions about vehicle X (153). The access request can be verified by the repossession service, which responds by providing available information and functions (154) for vehicle X. The available information and functions can be displayed as part of a graphical user interface in a browser or specialized application (as a portal to the repossession service) at a client device of the repossession agent 121-1. A repossession agent 121-1 can select/enact a function of the repossession service via the graphical user interface to enact further capabilities (155), such as determining the last known position of the vehicle or, in some cases, disabling the vehicle's starter.

FIGS. 2A and 2B show screens illustrating an example scenario for requesting repossession. For example, a title holder's representative may log into their account management software and/or their account with repossession software and select from a list of vehicles owned or managed by the title holder. Then, as illustrated in FIG. 2A, a repossession request can be made via example user interface 200, where a particular vehicle to repossess can be selected and a request to a repossession agent be arranged.

The example user interface 200 can include a first region 210 displaying vehicle information and a second region 220 with which a user may interact to request repossession. In the first region 210, one or more of identifying information 211 such as VIN, License, and Year/Make/Model, a photograph of the vehicle 212, last known location address 213, and last known location longitude/latitude 214 may be included.

In the second region 220, commands and input fields may be provided including one or more of a selection of agent 221, removal of agent 222, selection of mode for notification (e.g., email 223 or text message 224), cancelation of request 225, and confirmation of request for repossession 226. In some cases, another or a different agent may be added 226. In the example scenario, “Rashid Zonaid” is the selected agent (221) who will be sent a notification via email 223. In response to receiving a selection to “confirm repossession” 226, the selected notifications can be sent to the designated repossession agents as described with respect to FIG. 1. Although not shown, the user interface 200 may also include scheduling functionality so that the user may schedule when the repossession agent is to be notified and/or when to service the request.

FIG. 2B shows an example interface message 250 that may be displayed to the repossession requestor to verify that a repossession request notification has been sent, by the repossession service to the selected repossession agent.

FIGS. 3A and 3B show screens illustrating an example scenario for a repossession agent. Referring to FIG. 3A, a repossession agent may receive a notification via a mobile application client 300 running on a mobile device 301. The mobile application client 300 refers to an application that might receive text or email messages on a mobile platform such as a smartphone or tablet. In the illustrated example, the notification message requested via the interface shown in FIG. 2A is received by the repossession agent as message 305.

In the example message 305, the year, make, model, and license plate number of the vehicle to be repossessed is shown. However, it should be understood that both this example as well as the one described with respect to FIGS. 2A and 2B is merely one implementation. Various modifications and variations are contemplated.

Embedded in message 305 is a link 310 containing encoding that, when selected, communicates with the repossession service as described herein (in varying cases, through a web browser or other application). Enough information can be contained in the link encoding to identify to the repossession service the specific repossession agent and his or her associated access credentials, the specific vehicle to be repossessed, and the available authorized functions that the repossession agent may perform with respect to the vehicle. By executing the link 310 embedded in message 305, the example mobile device 301 surfaces the interface shown in FIG. 3B. The interface may be rendered in a browser application or in an app or other application associated with the repossession service.

Repossession agent user interface 350 highlights some of the interface elements and functions appropriate to fulfilling and responding to a repossession request. It should be noted that other supporting interfaces (not shown here) may depict other functions appropriate to the administration or management of repossession requests from the perspective of repossession agents.

In the example shown in FIG. 3B, a vehicle information region 351 can be provided to display the year, make, model, and license plate number of the vehicle requested for repossession, for example, a “2001 Ford Escort”.

In some implementations, a real-time tracking capability may allow the vehicle to be located at its current position. This tracking ability is reflected by the example command “locate now” 352, which may cause a request to be sent to the repossession service to access the vehicle's current position and display the location on the surface of the repossession agent interface.

A map 360 may also be included, showing the purported vehicle location 361 as well as the surrounding streets or terrain. In some cases, when included, the mapping capability to locate address and/or GPS coordinates and to display mapping visual elements such as streets or satellite views may be provided using third party mapping services. These mapping services may be accessible via application programming interfaces (APIs) exposed by the underlying mapping service. Examples of third-party mapping services are the Google® Maps API and Microsoft Bing® Maps API.

As shown in the example in FIG. 3B, an interface element 362 also may be provided showing the latitude and longitude of the current or last known location of the vehicle. If real-time tracking is available and the vehicle is currently in motion, the interface element 362 may dynamically adjust the longitude and latitude and may show speed and heading information. Another element may display the street address 363 of the selected map location.

Other capabilities which may be provided in some implementations of the service are “last position” information (364) and location history reports (365). These capabilities allow the repossession agent to view the last recorded locations of the vehicle and to review reports on vehicle movements. These capabilities allow the repossession agent to monitor known areas at specific times in order to enhance the possibility of vehicle repossession and recovery.

In order to provide the vehicle location history, last position, and real-time tracking capabilities available in some implementations, the repossession service may use a vehicle location service. In some cases, location information may be gathered in real-time by on-vehicle installed devices put in place by the title holder. These devices may send location information to a vehicle location service and may be updated upon request or at periodic intervals.

In some cases, the last position, current location, and historical location information may be gleaned from vehicle location services having data recorded by fixed or mobile commercial license-plate readers. A vehicle location service of this type uses a network of license plate cameras mounted on private vehicles, buildings, and roadways to record the license plate information of passing vehicles. Subscribers to a vehicle location service of this type may elect to be notified of particular licenses plates whenever a target license plate number has been recorded by the service.

An example of a vehicle location service is the Skypatrol® Defender service, which utilizes an on-board device to communicate vehicle location history to an accessible service. An example of a vehicle location service using license plate readers is the DRN SmartRecovery™ product. The features and functions of vehicle location services, like mapping services above, may be accessible to the repossession service via API.

In some cases, the capability to remotely disable and re-enable the starter of a vehicle may be provided via a vehicle starter control function 370. This capability enables the repossession agent to immobilize a vehicle so that it may not move from a pickup location until the repossession agent arrives at the location. The starter may then be re-enabled to move the vehicle to a designated storage location. The availability of this function may depend on whether capable on-vehicle devices are installed on the target vehicle.

Another aspect of the repossession agent interface may include the ability to dynamically adjust the available interface functions in response to access permissions associated to the specific repossession agent. Different repossession agents may receive greater or lesser permissions to perform certain functions, like disabling a vehicle starter, depending on their trust level. In addition, some interface functions (e.g., “disable starter” and “locate now”) may not be available in all vehicles depending on whether on-board devices are installed on the vehicle.

A “repossession complete” element 371 may allow the repossession agent to mark the vehicle as repossessed with the repossession service, which may in turn be communicated back to the repossession requestor/title holder.

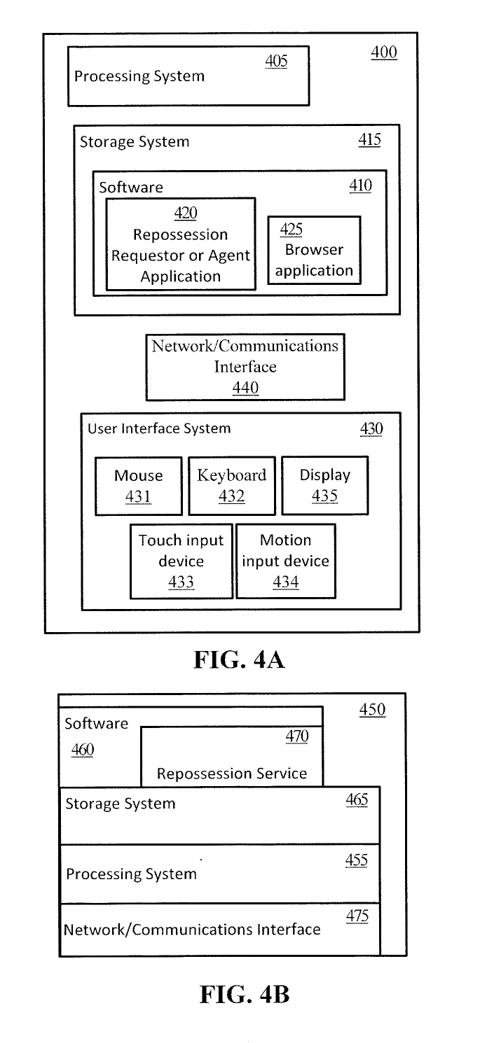

FIGS. 4A and 4B present block diagrams illustrating components of systems that may be used to implement the techniques described herein.

Referring to FIG. 4A, system 400 may represent a computing device such as, but not limited to, a personal computer, a tablet computer, a reader, a mobile device, a personal digital assistant, a wearable computer, a smartphone, a laptop computer (notebook or netbook), a gaming device or console, a desktop computer, or a smart television. Accordingly, more or fewer elements described with respect to system 400 may be incorporated to implement a particular computing device.

System 400, for example, includes a processing system 405 of one or more processors to transform or manipulate data according to the instructions of software 410 stored on a storage system 415. Examples of processors of the processing system 405 include general purpose central processing units, application specific processors, and logic devices, as well as any other type of processing device, combinations, or variations thereof.

The software 410 can include an operating system and application programs such as a repossession requestor application and/or repossession agent application 420 and/or web browsing application 425. Device operating systems generally control and coordinate the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 4A, can be thought of as additional, nested groupings within the operating system space, each containing an OS, application programs, and APIs.

Storage system 415 may comprise any computer readable storage media readable by the processing system 405 and capable of storing software 410 including the repossession requestor application and/or repossession agent application 420 and/or browsing application 425.

Storage system 415 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium a propagated signal or carrier wave.

In addition to storage media, in some implementations, storage system 415 may also include communication media over which software may be communicated internally or externally.

Storage system 415 may be implemented as a single storage device but may also be implemented across multiple storage devices or sub-systems co-located or distributed relative to each other. Storage system 415 may include additional elements, such as a controller, capable of communicating with processor 405.

Software 410 may be implemented in program instructions and among other functions may, when executed by system 400 in general or processing system 405 in particular, direct system 400 or the one or more processors of processing system 405 to operate as described herein.

In general, software may, when loaded into processing system 405 and executed, transform computing system 400 overall from a general-purpose computing system into a special-purpose computing system customized to retrieve and process the information for a repossession requestor application and/or repossession agent application as described herein for each implementation. Indeed, encoding software on storage system 415 may transform the physical structure of storage system 415. The specific transformation of the physical structure may depend on various factors in different implementations of this description. Examples of such factors may include, but are not limited to the technology used to implement the storage media of storage system 415 and whether the computer-storage media are characterized as primary or secondary storage.

The system can further include user interface system 430, which may include input/output (I/O) devices and components that enable communication between a user and the system 400. User interface system 430 can include input devices such as a mouse 431, track pad (not shown), keyboard 432, a touch device 433 for receiving a touch gesture from a user, a motion input device 434 for detecting non-touch gestures and other motions by a user, a microphone for detecting speech (not shown), and other types of input devices and their associated processing elements capable of receiving user input.

The user interface system 430 may also include output devices such as display screens 435, speakers (not shown), haptic devices for tactile feedback (not shown), and other types of output devices. In certain cases, the input and output devices may be combined in a single device, such as a touchscreen display which both depicts images and receives touch gesture input from the user. Visual output may be depicted on the display 435 in myriad ways, presenting graphical user interface elements, text, images, video, notifications, virtual buttons, virtual keyboards, or any other type of information capable of being depicted in visual form.

The user interface system 430 may also include user interface software and associated software (e.g., for graphics chips and input devices) executed by the OS in support of the various user input and output devices. The associated software assists the OS in communicating user interface hardware events to application programs using defined mechanisms. The user interface system 430 including user interface software may support a graphical user interface, a natural user interface, or any other type of user interface. For example, the repossession requestor interface surfaces and/or repossession agent interface surfaces described herein may be presented through user interface system 430.

Communications interface 440 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

It should be noted that many elements of system 400 may be included in a system-on-a-chip (SoC) device. These elements may include, but are not limited to, the processing system 405, a communications interface 440, and even elements of the storage system 415.

Computing system 400 is generally intended to represent a computing system with which software is deployed and executed in order to implement an application, component, or service for a repossession requestor application and/or repossession agent application, as described herein. In some cases, aspects of computing system 400 may also represent a computing system on which software may be staged and from where software may be distributed, transported, downloaded, or otherwise provided to yet another computing system for deployment and execution, or yet additional distribution.

Certain aspects described herein may be carried out on a system such as shown in FIG. 4B. Referring to FIG. 4B, system 450 may be implemented within a single computing device or distributed across multiple computing devices or sub-systems that cooperate in executing program instructions. The system 450 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 450 can include a processing system 455, which may include one or more processors and/or other circuitry that retrieves and executes software 460 from storage system 465. Processing system 455 may be implemented within a single processing device but may also be distributed across multiple processing devices or sub-systems that cooperate in executing program instructions.

Examples of processing system 455 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

As with storage system 415, storage system 465 can include any computer readable storage media readable by processing system 455 and capable of storing software 460. Storage system 465 may be implemented as a single storage device but may also be implemented across multiple storage devices or sub-systems co-located or distributed relative to each other. Storage system 465 may include additional elements, such as a controller, capable of communicating with processing system 455.

Software 460 may be implemented in program instructions and among other functions may, when executed by system 450 in general or processing system 455 in particular, direct the system 450 or processing system 455 to operate as described herein for enabling a repossession service providing requestor application and/or repossession agent functionality. Software 460 may provide program instructions that implement a repossession service 470 as well as (or alternatively) provide program instructions for enabling a requestor application and/or repossession agent user interface functionality.

Software 460 may also include additional processes, programs, or components, such as operating system software or other application software. Software 460 may also include firmware or some other form of machine-readable processing instructions executable by processing system 455.

System 450 may represent any computing system on which software 460 may be staged and from where software 460 may be distributed, transported, downloaded, or otherwise provided to yet another computing system for deployment and execution, or yet additional distribution.

In embodiments where the system 450 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 475 may be included, providing communication connections and devices that allow for communication between system 450 and other computing systems (not shown) over a communication network or collection of networks (not shown) or the air.

It should be noted that many elements of system 450 may be included in a system-on-a-chip (SoC) device. These elements may include, but are not limited to, the processing system 455, the communications interface 475, and even elements of the storage system 465.

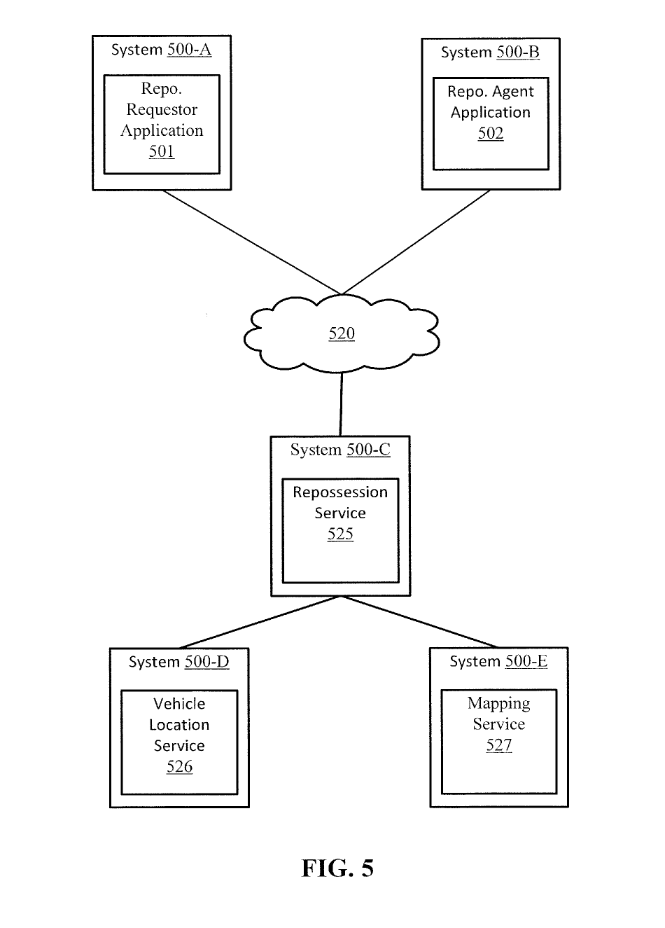

FIG. 5 illustrates an example system architecture in which the described systems and techniques may be carried out. Referring to FIG. 5, a repossession requestor application 501 may be implemented on a computing system 500-A such as described with respect to system 400 of FIG. 4A. The user of the repossession requestor application 501 may utilize the application to manage and request repossessions of vehicles as described above with respect to FIGS. 2A and 2B.

In addition, a repossession agent application 502 may be implemented on a computing system 500-B such as described with respect to system 400 of FIG. 4A. The user of the repossession agent application 502 may utilize the application to view vehicles designated for repossession, check locations and movement history, and disable vehicles as described above with respect to FIGS. 3A and 3B.

Repossession requestor application 501 and/or repossession agent application 502 may communicate over network 520 with repossession service 525 contained on system 500-C, which may be a particular instance of system 450 described in FIG. 4B. Repossession service may be embodied in data structures and processing functions allowing vehicle management, access controls, and user interface functionality to repossession requestor application 501 and/or repossession agent application 502.

In turn, repossession service 525 may communicate over network with vehicle location service 526 contained on system 500-D, which may be a particular instance of system 450 described in FIG. 4B. Repossession service 525 may also communicate over network with mapping service 527 contained on system 500-E, which may be a particular instance of system 450 described in FIG. 4B. Vehicle location service 526 and mapping service 527 may provide capabilities as described herein with respect to FIG. 3B.

Repossession requestor application 501 and/or repossession agent application 502 may in some instances communicate with repossession service 525 using application programming interfaces (APIs) to send requests and receive information. In turn, repossession service 525 may communicate with vehicle location service 526 and mapping service 527 via API to provide underlying functionality.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. An API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic.

The API-calling component may be a local component (i.e., on the same data processing system as the API-implementing component) or a remote component (i.e., on a different data processing system from the API-implementing component) that communicates with the API-implementing component through the API over a network. An API is commonly implemented over the Internet such that it consists of a set of Hypertext Transfer Protocol (HTTP) request messages and a specified format or structure for response messages according to a REST (Representational state transfer) or SOAP (Simple Object Access Protocol) architecture. Here, repossession requestor application 501 and/or repossession agent application 502 may connect to remote services 525 over the Internet using APIs structured using the REST or SOAP protocols. Repossession service 525 may connect to services 526 and 527 using similar techniques.

The network 520 can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

It should be understood that the examples and embodiments described herein are for illustrative purposes only and that various modifications or changes in light thereof will be suggested to persons skilled in the art and are to be included within the spirit and purview of this application.

What is claimed is:

1. A method for enhancing the management of vehicle repossession requests, comprising:
in response to receiving a request for repossessing a vehicle, generating a notification to a repossession agent, the notification comprising a link permitting access to vehicle information; and
in response to receiving a request to access the vehicle information through the link, providing the vehicle information.

2. The method of claim 1, wherein providing the vehicle information comprises providing a limited access to information and functionality related to the vehicle.

3. The method of claim 2, wherein the limited access is based on an access level of the repossession agent.

4. The method of claim 3, wherein the link encodes the access level.

5. The method of claim 2, wherein the functionality comprises a vehicle starter control function, wherein in response to receiving an indication of a selection of the vehicle starter control function, the method further comprising: requesting disengagement of a vehicle's starter.

6. The method of claim 1, wherein the notification comprises at least one of an email message, text message, and application notification message.

7. The method of claim 1, wherein the vehicle information comprises a current location.

8. The method of claim 1, wherein the vehicle information comprises a last known position.

9. The method of claim 1, wherein the vehicle information comprises a vehicle's location history.

10. The method of claim 1, wherein the vehicle information comprises a map to one or more of the vehicle's current location and the vehicle's last known position.

11. A system for enhancing the management of vehicle repossession requests, comprising:
one or more computer readable storage media; and
a service embodied in program instructions stored on the one or more computer readable storage media that, when executed by a processing system, direct the processing system to:
in response to receiving a request for repossessing a vehicle, generate a notification to a repossession agent, the notification comprising a link permitting access to vehicle information; and
in response to receiving a request to access the vehicle information through the link, provide the vehicle information.

12. The system of claim 11, wherein the notification comprises at least one of an email message, text message, and application notification message.

13. The system of claim 11, wherein the vehicle information comprises a current location.

14. The system of claim 11, wherein the vehicle information comprises a last known position.

15. The system of claim 11, wherein the vehicle information comprises a vehicle's location history.

16. The system of claim 11, wherein the vehicle information comprises a map to one or more of the vehicle's current location and the vehicle's last known position.

17. The system of claim 11, wherein the program instructions further direct the processing system to: provide one or more functions with which the repossession agent may interact with the repossession service.

18. The system of claim 17, wherein the one or more functions comprise a vehicle starter control function.

19. The system of claim 17, wherein the vehicle information and the one or more functions depend on an access level of the repossession agent.

20. The system of claim 17, wherein the program instructions further direct the processing system to communicate with at least one of a vehicle location service and an on-board vehicle device according to the one or more functions with which the repossession agent may interact.
